(19) United States
(12) Patent Application Publication
(10) Pub. No.: US 2021/0406732 A1
(43) Pub. Date: Dec. 30, 2021

(54) METHOD FOR BUILDING MACHINE LEARNING MODELS FOR ARTIFICIAL INTELLIGENCE BASED INFORMATION TECHNOLOGY OPERATIONS

(71) Applicants: Pavan Thatha, Karnataka (IN); Ruma Mukherjee, Karnataka (IN); Soma Kohli, Karnataka (IN); Chiranjeev Joshi, Karnataka (IN); Amanpreet Singh, Punjab (IN)

(72) Inventors: Pavan Thatha, Karnataka (IN); Ruma Mukherjee, Karnataka (IN); Soma Kohli, Karnataka (IN); Chiranjeev Joshi, Karnataka (IN); Amanpreet Singh, Punjab (IN)

(73) Assignee: unisys corporation, Blue Bell, PA (US)

(21) Appl. No.: 17/177,259

(22) Filed: Feb. 17, 2021

(30) Foreign Application Priority Data
Jun. 25, 2020 (IN) 202011026883

(51) Int. Cl. G06N 5/04; G06N 20/00

(52) U.S. Cl. CPC G06N 5/04; G06N 20/00

(57) ABSTRACT

A method and system for forecasting resource utilization of an information technology system having a plurality of system components. The method includes classifying the plurality of system components based on at least one resource utilization metric. The method also includes determining at least one reference component in each class from among the components classified within the respective class. The method also includes building a representative machine learning model for each reference component in each class. The method also includes applying the representative machine learning model to all system components within the respective class. Applying the representative machine learning model to all system components within the respective class forecasts the resource utilization of all system components in the information technology system without building a machine learning model for each system component in the information technology system.

### BACKGROUND

### Field

The instant disclosure relates generally to artificial intelligence information technology, and in particular to machine learning models for artificial intelligence information technology.

### Description of the Related Art

The term AIOps refers to artificial intelligence for information technology (IT) operations. AIOps refers to the way data and information from an application environment are managed using artificial intelligence. AIOps typically uses machine learning and data science to provide a real-time understanding of issues affecting the availability or performance of an IT system. AIOps involves technology platforms that automate and enhance IT operations by using analytics and machine learning to analyze data collected from various IT operations tools and devices to identify and react to issues in real time.

AIOps users have infrastructure needs associated with IT systems having many component devices and/or server configurations, such as virtual machines (VMs) and server clusters. Virtual machines are operating systems or application environments that emulate or imitate dedicated hardware, thus exhibiting the behavior of a separate computer system. Server clusters are groups of servers working together on one system to provide users with greater availability.

For AIOps users, one of the main goals of AIOps is to forecast the resource utilization for the entire infrastructure of an IT system. One mechanism to forecast the resource utilization for the infrastructure is to apply one or more machine learning (ML) models to each device and/or server within the entire infrastructure of the IT system. Machine learning models can include various regression algorithms, instance-based algorithms, decision tree algorithms and other suitable algorithms.

However, different infrastructures typically have different configurations. Also, for an infrastructure that includes a relatively larger number of devices and/or servers (e.g., more than 5000 devices and/or servers), it typically is unusually challenging and relatively impractical to build, develop and maintain one or more machine learning models for each device and/or server within the infrastructure.

There is a need for a method and system for providing resource utilization for relatively large infrastructures and/or infrastructures having different configurations using a reduced or minimized number of machine learning or other representative models.

### SUMMARY

Disclosed is a method and system for forecasting resource utilization of an information technology system having a plurality of system components. The method includes classifying the plurality of system components based on at least one resource utilization metric. The method also includes determining at least one reference component in each class from among the components classified within the respective class. The method also includes building a representative machine learning model for each reference component in each class. The method also includes applying the representative machine learning model to all system components within the respective class. Applying the representative machine learning model to all system components within the respective class forecasts the resource utilization of all system components in the information technology system without building a machine learning model for each system component in the information technology system.

### BRIEF DESCRIPTION OF THE DRAWINGS

FIG. 1 is a schematic view of a conventional information technology (IT) system;

FIG. 2 is a schematic view of an information technology (IT) system using a reduced number of machine learning or other representative models to forecast resource utilization for the IT system, according to an embodiment; and

FIG. 3 is a flow diagram of a method for providing resource utilization for information technology system infrastructures using a reduced number of machine learning or other representative models to forecast resource utilization for the IT system, according to an embodiment.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting, and merely set forth some of the many possible embodiments for the claimed invention.

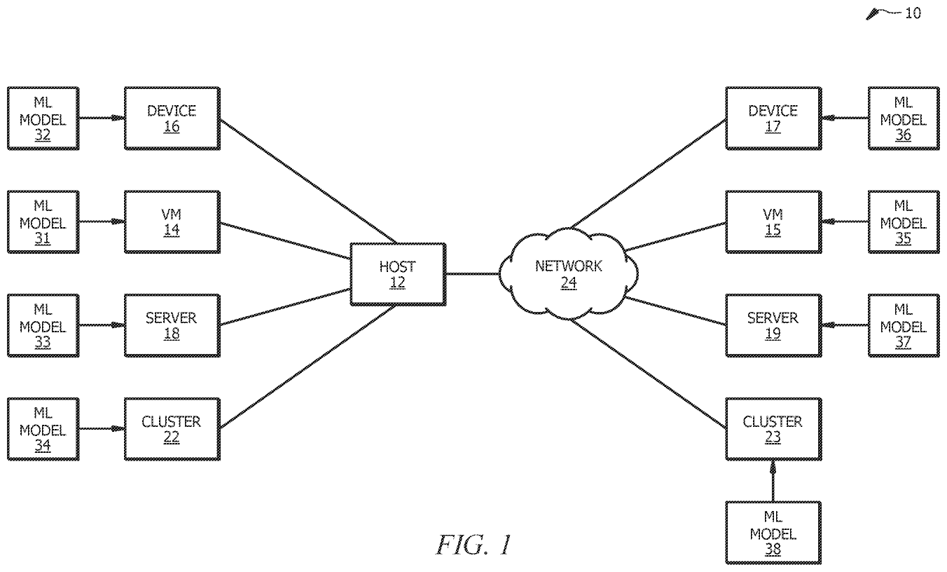

FIG. 1 is a schematic view of a conventional information technology (IT) system 10. The system 10 includes a host 12 coupled to several system components, such as one or more virtual machine (VM) devices 14,15 and other devices 16, 17, one or more servers 18, 19, and one or more server clusters and other clusters 22, 23. The host 12 can be coupled to one or more of the system components directly or via one or more networks 24, as shown.

As discussed hereinabove, one of the main goals of AIOps (artificial intelligence for information technology operations) is to forecast the resource utilization for the entire IT system 10. For example, various utilization metrics (such as CPU utilization, memory utilization and disk storage utilization) are collected and used to forecast future resource utilization for the IT system 10. One conventional manner in which to forecast the resource utilization for the IT system 10 is to apply one or more machine learning (ML) models or other suitable models to each system component in the IT system 10.

However, different IT systems typically have different configurations. Also, for an IT system that includes a relatively larger number of component devices and/or servers, it typically is relatively impractical and difficult to build, develop and maintain one or more machine learning models for each component within the IT system. For example, in the IT system 10 shown in FIG. 1, the conventional approach of providing a machine learning model to each component in the IT system 10 requires applying a separate and different machine learning model to each of the eight components in the IT system 10. That is, the IT system 10 would require the building, development and maintenance of eight separate and different machine learning models (e.g., machine learning models 31-38), with each machine learning model applied to one of the eight components in the IT system 10. For an IT system with a relatively larger number of components (e.g., more than 5000 devices and/or servers), the conventional approach of providing a machine learning model to each component in the IT system would require the building, development and maintenance of at least 5000 separate and different machine learning models for the components in the IT system.

According to an embodiment, forecasting resource utilization for an IT system involves building a set of representative machine learning models or other suitable models for various resource utilization metric classes (e.g., one representative machine learning model for each resource utilization metric class) and applying each representative machine learning model to all IT system components that fit a particular component class for the respective metric class. The components in the IT system are grouped or classified according to one or more similar patterns, e.g., one or more utilization metrics, such as memory utilization, and each representative machine learning model for that metric class is applied to all IT system components within the corresponding component group or class. In this manner, the total number of machine learning models required to forecast resource utilization for the entire IT system is reduced, while still providing at least one machine learning model to each component in the IT system.

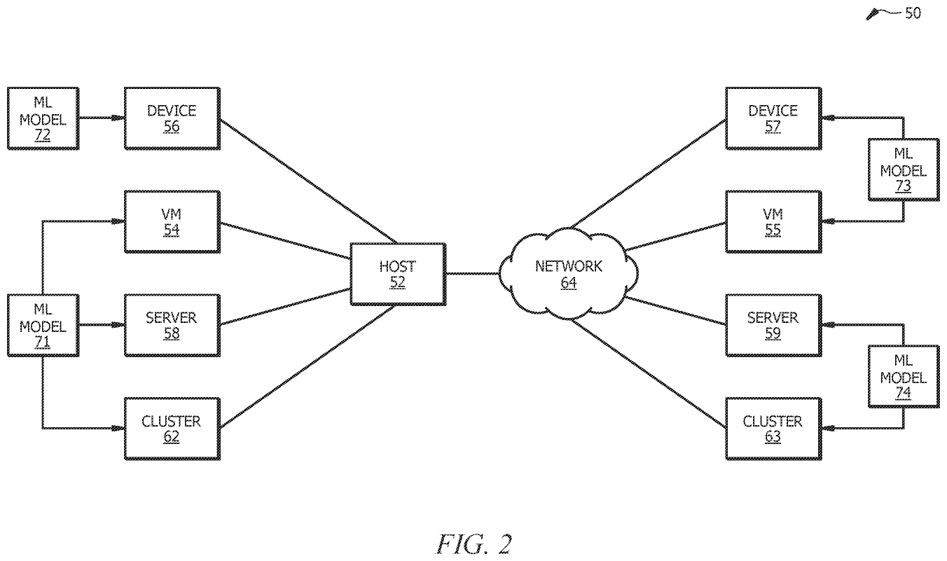

FIG. 2 is a schematic view of an information technology (IT) system 50, according to an embodiment. The system 50 includes a host 52 coupled to several system components, such as one or more virtual machine (VM) devices 54,55 and other devices 56, 57, one or more servers 58, 59, and one or more server clusters and other clusters 62, 63. The host 52 can be coupled to one or more of the system components directly or via one or more networks 64, as shown.

According to an embodiment, each of the components 54-63 is grouped or classified according to one or more similar patterns, e.g., one or more utilization metrics, such as CPU utilization, memory utilization and/or disk storage utilization. A single representative machine learning model or a set of one or more representative machine learning models or other suitable models is built for each grouping or classification, e.g., one representative machine learning model is built for each utilization metric class. For example, one representative machine learning model is built for each CPU utilization metric class, one representative machine learning model is built for each memory utilization metric class and one representative machine learning model is built for each disk storage utilization metric class. The representative machine learning model built for each metric class is then applied to all components grouped within that corresponding metric class.

For example, as shown in FIG. 2, components 54, 58, 62 have been grouped or classified into a first class, component 56 has been classified into a second class, components 59, 63 have been grouped or classified into a third class, and components 55, 57 have been grouped or classified into a fourth class, based on a particular utilization metric, e.g., memory utilization. One representative machine learning model is built for each of the four utilization metric classes, i.e., four representative machine learning models 71-74 are built. Then, the first representative machine learning model 71 is applied to all components in the first component class (i.e., components 54, 58, 62), the second representative machine learning model 72 is applied to all components in the second component class (i.e., component 56), the third representative machine learning model 73 is applied to all components in the third component class (i.e., components 55, 57), and the fourth representative machine learning model 74 is applied to all components in the fourth component class (i.e., components 59, 63).

Accordingly, based on the example shown in FIG. 2, each of the eight IT components within the IT system 50 has a representative machine learning model applied thereto using only four total representative machine learning models (i.e., machine learning models 71-74). Compared to the IT system 10 shown in FIG. 1, in which eight machine learning models (i.e., machine learning models 31-38) are needed to apply to the eight IT components within the IT system 10, the IT system 50 shown in FIG. 2 only needs four representative machine learning models to apply to the eight IT components within the IT system 50. Therefore, accordingly to an embodiment, the number of machine learning models needed to apply to all components within a given IT system can be greatly reduced, thus saving overall build, development and maintenance time, as well as deployment time, for the IT system 50.

According to an embodiment of the invention, representative machine learning models or other suitable models are built for various utilization metric classes so that IT system components with similar patterns (i.e., similar utilization metric classes) receive similar approximate predictions via the corresponding representative machine learning model for that particular class.

According to an embodiment, clustering based decisions are applied to the IT system components to determine the classification of each IT system component. For example, IT system components are segmented based on historic utilization (data distributions). Also, one or more clustering algorithms (e.g., centroid-based, density-based, distribution-based, hierarchical) can be used to determine the split of IT system components according to classification. One or more representative machine learning models are built for each classification and applied to all IT system components within the corresponding classification.

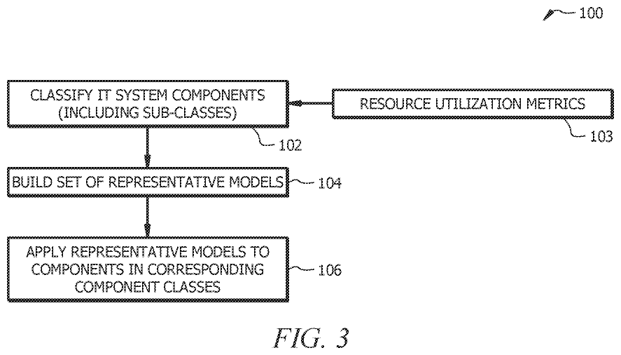

FIG. 3 is a flow diagram of a method 100 for providing resource utilization for information technology system infrastructures using a reduced number of machine learning or other representative models, according to an embodiment. The method 100 includes a step 102 of grouping or classifying the components in an IT system according to one or more similar patterns, e.g., one or more utilization metrics 103. Utilization metrics include CPU utilization, memory utilization, data storage utilization or other suitable utilization metric.

For example, using a particular metric (e.g., memory utilization), the components in the IT system are segmented into various clusters based on the historic utilization (data distributions) of each component. The components are segmented into various clusters using a k-means clustering algorithm or one or more other suitable clustering algorithms or other mechanisms. Using a k-means clustering algorithm, the components are segmented into k clusters.

Once the components are segmented into clusters, each cluster is profiled and labeled. For example, one type of classification scheme includes five classes: Underutilized, Moderate Low, Moderate Mid, Moderate High and Overutilized. It should be understood that profiling and labeling each cluster converts an unsupervised problem into a supervised problem, i.e., unlabeled data becomes labeled, tagged or classified data. For example, a Random Forest model, which is supervised, is developed so that all IT system components, including any new components to the IT system, get classified into a proper utilization class.

Once all of the IT system components have been classified into one of the classes, the IT system components can be further grouped or classified into sub-classes within the respective class, e.g., based on the stationary property of the component. For example, for a given class, a first sub-class will include all stationary components in that class and a second sub-class will include all non-stationary components in that class. Stationary components are components whose mean, variance and autocorrelation structure do not change over time.

As an example, consider having 10 components per class (5 stationary components and 5 non-stationary components). According to an embodiment, the 10 components in each class are designated as reference components. Accordingly, in the given example, there are 50 reference components (10 components*5 classes) for each utilization metric. If there are 3 utilization metrics (e.g., CPU utilization, memory utilization, data storage utilization), there are 150 reference components (10 components*5 classes*3 utilization metrics).

The method 100 also includes a step 104 of building a set of representative or reference machine learning models. Initially, a representative machine learning model is built for each reference component. Therefore, in the given example, for 150 reference components, 150 representative machine learning models are built (one representative machine learning model for each of the 150 reference components). Machine learning models are built using Auto Regressive Integrated Moving Average (ARIMA), which is a class of models that are fitted to time series data in such a way that future can be forecast based on the past values of the time series.

Once the representative (reference) machine learning models are built, the hyper parameters of each representative machine learning model are seeded, e.g., based on autocorrelation function (acf) values and partial autocorrelation function (pacf) values.

Once each representative machine learning model is seeded with hyper parameters, the representative machine learning models are used in a grid search algorithm for an ARIMA model. That is, the machine learning models are further refined using a grid search algorithm or other suitable algorithm.

The method 100 also includes a step 106 of applying the representative machine learning models within a given class to each IT system component within that given class. As discussed hereinabove, applying the representative machine learning models within a given class to each IT system component within that given class forecasts the resource utilization of all system components in that class. In this manner, according to an embodiment, applying the representative machine learning models of each class to each IT system component within the respective class forecasts the resource utilization of all system components in the IT system without having to build a machine learning model for each system component in the IT system.

It will be apparent to those skilled in the art that many changes and substitutions can be made to the embodiments described herein without departing from the spirit and scope of the disclosure as defined by the appended claims and their full scope of equivalents.

1. A method for forecasting resource utilization of an information technology system having a plurality of system components, the method comprising:
classifying the plurality of system components based on at least one resource utilization metric;
determining at least one reference component in each class from among the components classified within a respective class;
building a representative machine learning model for each reference component in each class; and
for each class, applying the representative machine learning model to all system components within the respective class,
wherein applying the representative machine learning model to all system components within the respective class, for each class, provides forecasts for the resource utilization of all system components in the information technology system without building a machine learning model for each system component in the information technology system.

2. The method as recited in claim 1, wherein the at least one resource utilization metric is at least one of CPU utilization, memory utilization or disk storage utilization.

3. The method as recited in claim 1, wherein classifying the plurality of system components comprises classifying the plurality of system components based on data distributions of the plurality of system components.

4. The method as recited in claim 1, wherein clustering based decisions are used to classifying the plurality of system components.

5. The method as recited in claim 1, wherein representative machine learning models are built using at least one Auto Regressive Integrated Moving Average (ARIMA) model.

6. The method as recited in claim 1, wherein classifying the plurality of system components comprises classifying each system component into one of an Underutilized class, a Moderate Low class, a Moderate Mid class, a Moderate High class or an Overutilized class.

7. The method as recited in claim 1, wherein classifying the plurality of system components further comprises classifying each system component within each class into a sub-class within the respective class.

8. The method as recited in claim 7, wherein classifying each system component within each class into a sub-class within the respective class is based on a stationary property of the respective system component.

9. The method as recited in claim 1, wherein building a representative machine learning model for each reference component in each class further comprises building a set of representative machine learning models for each reference component in each class.

10. The method as recited in claim 1, wherein the plurality of system components includes at least one of a virtual machine device, a server or a server cluster.

11. An information technology system, comprising:
a host; and
a plurality of system components coupled to the host,
wherein the host is configured to forecast resource utilization of the plurality of system components by:
classifying the plurality of system components based on at least one resource utilization metric,
determining at least one reference component in each class from among the components classified within a respective class,
building a single representative machine learning model for each reference component in each class, and
for each class, applying the single representative machine learning model to all system components within the respective class,
wherein applying the representative machine learning model to all system components within the respective class, for each class, provides forecasts for the resource utilization of all system components in the information technology system without building a machine learning model for each system component in the information technology system.

12. The system as recited in claim 11, wherein the at least one resource utilization metric is at least one of CPU utilization, memory utilization or disk storage utilization.

13. The system as recited in claim 11, wherein classifying the plurality of system components comprises classifying the plurality of system components based on data distributions of the plurality of system components.

14. The system as recited in claim 11, wherein clustering based decisions are used to classifying the plurality of system components.

15. The system as recited in claim 11, wherein representative machine learning models are built using at least one Auto Regressive Integrated Moving Average (ARIMA) model.

16. The system as recited in claim 11, wherein classifying the plurality of system components comprises classifying each system component into one of an Underutilized class, a Moderate Low class, a Moderate Mid class, a Moderate High class or an Overutilized class.

17. The system as recited in claim 11, wherein classifying the plurality of system components further comprises classifying each system component within each class into a sub-class within the respective class.

18. The system as recited in claim 17, wherein classifying each system component within each class into a sub-class within the respective class is based on a stationary property of the respective system component.

19. The system as recited in claim 11, wherein the plurality of system components includes at least one of a virtual machine device, a server or a server cluster.

20. The system as recited in claim 11, wherein the plurality of system components is coupled to the host via at least one network.
